(19) United States
(12) Patent Application Publication
(10) Pub. No.: US 2026/0146115 A1
(43) Pub. Date: May 28, 2026

(54) POLYETHYLENE COMPOSITION

(71) Applicant: Dow Global Technologies LLC, Midland, MI (US)

(72) Inventors: Carmelo Declet Perez, Freeport, TX (US); Jacquelyn A. deGroot, Freeport, TX (US)

(21) Appl. No.: 19/122,810

(22) PCT Filed: Oct. 11, 2023
(86) PCT No.: PCT/US2023/034894

§ 371 Date: Apr. 21, 2025

Related U.S. Application Data
(60) Provisional application No. 63/422,075, filed on Nov. 3, 2022.

(51) Int. Cl. C08F 210/16

(52) U.S. Cl. CPC C08F 210/16

(57) ABSTRACT

The present disclosure provides a composition. In an embodiment, a polyethylene composition is provided and includes (A) at least 25 wt % of a high density polyethylene having (i) a density from 0.950 g/cm3 to 0.970 g/cm3, (ii) a melt index (I₂) from 0.2 g/10 minutes to 2 g/10 minutes, and (iii) a molecular weight distribution (M_{w(abs)}/M_{n(abs)}) from greater than 4.0 to 30.0. The polyethylene composition also includes (B) a polyethylene enhancer that is an ethylene/C₄-C₈ α-olefin copolymer having (i) a density from 0.880 g/cm³ to 0.910 g/cm³, (ii) a melt index from 0.2 to 2.0 g/10 minutes, and (iii) LCBf/1000C value less than 0.015. The polyethylene composition has (1) a density from 0.915 g/cm³ to 0.925 g/cm³, (2) a melt index (I₂) from 0.3 g/10 minutes to 1.0 g/10 minutes, (3) a Mw(abs)/Mn(abs) value from 5.0 to 11.0, (4) a low M-SCBDI value from 9.0 to 25.0, (5) a high M-SCBDI value from −8.0 to −12.0, (6) a first polyethylene fraction having (a) at least one peak in a temperature range from 40° C. to 79° C., and (b) an average M_{w} from 100,000 g/mol to 200,000 g/mol on an elution profile via improved comonomer composition distribution (iCCD) analysis method, (7) a second polyethylene fraction having (a) at least one peak in a temperature range from 800 C and 120° C., and (b) an average M_{w} from 90,000 g/mol to 250,000 g/mol on the elution profile via improved iCCD analysis method, and (8) a ratio of the average M_{w} of the first polyethylene fraction to the average M_{w} of the second polyethylene fraction is from 0.6 to 1.2. The present disclosure also provides a film made from the polyethylene composition.

### BACKGROUND

Known are polyethylene compositions for packaging applications, films, multilayer structures, and packaging articles made therefrom. For packaging applications, polyethylene compositions require a combination of toughness while exhibiting good tear strength. Balancing enhanced abuse performance (e.g., dart, puncture, and tear) without sacrificing overall material stiffness continues to be a general challenge in the field. Materials capable of achieving that better balance of packaging performance are increasingly needed as packaging design moves towards monomaterial structures to support packaging sustainability efforts.

The art recognizes the on-going need for polyethylene compositions suitable for packaging applications having a good balance of physical properties at desirable polymer composition densities.

### SUMMARY

The present disclosure provides a composition. In an embodiment, a polyethylene composition is provided and includes (A) at least 25 wt % of a high density polyethylene having (i) a density from 0.950 g/cm³ to 0.970 g/cm³, (ii) a melt index (I₂) from 0.2 g/10 minutes to 2 g/10 minutes, and (iii) a molecular weight distribution (M_{w(abs)}/M_{n(abs)}) from greater than 4.0 to 30.0. The polyethylene composition also includes (B) a polyethylene enhancer that is an ethylene/C₄-C₈ α-olefin copolymer having (i) a density from 0.880 g/cm³ to 0.910 g/cm³, (ii) a melt index from 0.2 to 2.0 g/10 minutes, and (iii) LCBf/1000C value less than 0.015. The polyethylene composition has (1) a density from 0.915 g/cm³ to 0.925 g/cm³, (2) a melt index (I₂) from 0.3 g/10 minutes to 1.0 g/10 minutes, (3) a Mw(abs)/Mn(abs) value from 5.0 to 11.0, (4) a low M-SCBDI value from 9.0 to 25.0, (5) a high M-SCBDI value from −8.0 to −12.0, (6) a first polyethylene fraction having (a) at least one peak in a temperature range from 40° C. to 79° C., and (b) an average M_{w} from 100,000 g/mol to 200,000 g/mol on an elution profile via improved comonomer composition distribution (iCCD) analysis method, (7) a second polyethylene fraction having (a) at least one peak in a temperature range from 80° C. and 120° C., and (b) an average M_{w} from 90,000 g/mol to 250,000 g/mol on the elution profile via improved iCCD analysis method, and (8) a ratio of the average M_{w} of the first polyethylene fraction to the average M_{w} of the second polyethylene fraction is from 0.6 to 1.2.

The present disclosure also provides a film made from the polyethylene composition.

### BRIEF DESCRIPTION OF THE DRAWINGS

FIG. 1 provides a graph of short chain branching distribution (SCBD) across molecular weight (Log M) and values for calculating molecular weight short chain branching distribution index (M-SCBDI) for comparative sample 1.

FIG. 2 provides a graph of short chain branching distribution (SCBD) across molecular weight (Log M) and values for calculating M-SCBDI for comparative sample 3.

FIG. 3 provides a graph of short chain branching distribution (SCBD) across molecular weight (Log M) and values for calculating M-SCBDI for comparative sample 4.

FIGS. 4-5 are graphs of short chain branching distribution (SCBD) across molecular weight (Log M) and values for calculating M-SCBDI for inventive example 1.

FIG. 6 provides a graph of short chain branching distribution (SCBD) across molecular weight (Log M) and values for calculating M-SCBDI for inventive example 3.

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure).

The numerical ranges disclosed herein include all values from, and including, the lower and upper value. For ranges containing explicit values (e.g., from 1 or 2, or 3 to 5, or 6, or 7), any subrange between any two explicit values is included (e.g., the range 1-7 above includes subranges of from 1 to 2; from 2 to 6; from 5 to 7; from 3 to 7; from 5 to 6; etc.).

Unless stated to the contrary, implicit from the context, or customary in the art, all parts and percents are based on weight and all test methods are current as of the filing date of this disclosure.

The terms “blend” or “polymer blend,” as used, refers to a mixture of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art. The blend may be effected by physically mixing the two or more polymers on the macro level (for example, melt blending resins or compounding), or the micro level (for example, simultaneous forming within the same reactor).

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination.

An “ethylene-based polymer” is a polymer that contains more than 50 mole percent (wt %) polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Ethylene-based polymer may include ethylene copolymerized with an α-olefin (e.g., C₃-C₂ α-olefin, or C₄-C₈ α-olefin) and/or unsaturated ester.

The term “ethylene monomer,” or “ethylene,” as used herein, refers to a chemical unit having two carbon atoms with a double bond there between, and each carbon bonded to two hydrogen atoms, wherein the chemical unit polymerizes with other such chemical units to form an ethylene-based polymer composition.

A “heteroatom” is an atom other than carbon or hydrogen. The heteroatom can be a non-carbon atom from Groups IV, V, VI and VII of the Periodic Table. Nonlimiting examples of heteroatoms include: F, N, O, P, B, S, and Si.

A “hydrocarbon” is a compound containing only hydrogen atoms and carbon atoms. A “hydrocarbonyl” (or “hydrocarbonyl group”) is a hydrocarbon having a valence (typically univalent). A hydrocarbon can have a linear structure, a cyclic structure, or a branched structure.

“Linear low density polyethylene” (or “LLDPE”) is a linear ethylene/α-olefin copolymer containing heterogeneous short-chain branching distribution comprising units derived from ethylene and units derived from at least one C₃-C₁₀ α-olefin comonomer or at least one C₄-C₈ α-olefin comonomer, or at least one C₆-C₈ α-olefin comonomer. LLDPE is characterized by little, if any, long chain branching, in contrast to conventional LDPE. LLDPE has a density from 0.910 g/cc, or 0.915 g/cc, or 0.920 g/cc, or 0.925 g/cc to 0.930 g/cc, or 0.935 g/cc, or 0.940 g/cc. Nonlimiting examples of LLDPE include TUFLIN™ linear low density polyethylene resins and DOWLEX™ polyethylene resins, each available from the Dow Chemical Company; and MARLEX™ polyethylene (available from Chevron Phillips).

“Low density polyethylene” (or “LDPE”) consists of ethylene homopolymer, or ethylene copolymer with acrylate, vinyl acetate, and/or vinyl silane as comonomer, the LDPE has a density from 0.915 g/cc to 0.940 g/cc and contains long chain branching with broad molecular weight distribution (MWD). LDPE is typically produced by way of high pressure free radical polymerization (tubular reactor or autoclave with free radical initiator). Nonlimiting examples of LDPE include MarFlex™ (Chevron Phillips), LUPOLEN™ (LyondellBasell), as well as LDPE products from Borealis, Ineos, ExxonMobil, and others.

“Medium density polyethylene” (or “MDPE”) is an ethylene homopolymer, or an ethylene/α-olefin copolymer comprising at least one C₃-C₁₀ α-olefin, or a C₃-C₄ α-olefin, that has a density from 0.926 g/cc to 0.940 g/cc.

An “olefin” is an unsaturated, aliphatic hydrocarbon having a carbon-carbon double bond.

An “olefin-based polymer” (interchangeably referred to as “polyolefin”) is a polymer that contains a majority weight percent of polymerized olefin monomer (based on the total amount of polymerizable monomers), and optionally, may contain at least one comonomer. Nonlimiting examples of olefin-based polymer include ethylene-based polymer and propylene-based polymer.

The term “polymer” or a “polymeric material,” as used herein, refers to a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “propylene-based polymer” is a polymer that contains more than 50 mole percent polymerized propylene monomer (based on the total amount of polymerizable monomers) and, optionally, may contain at least one comonomer. Propylene-based polymer includes propylene homopolymer, and propylene copolymer (meaning units derived from propylene and one or more comonomers). The terms “propylene-based polymer” and “polypropylene” may be used interchangeably. A nonlimiting example of a propylene-based polymer (polypropylene) is a propylene/α-olefin copolymer with at least one C₂ or C₄-C₁₀ α-olefin comonomer.

### Test Methods

Coefficient of Friction (COF). The film sample to be tested is conditioned for at least 40 hours in an environment of 23° C. (±2° C.) and 50% R.H. (±10%) as per ASTM standards. Standard testing conditions are 23° C. (±2° C.) and 50% R.H. (±10%) as per ASTM standards.

Testing of the metal-to-film COF is carried out using an INSTRON 5564 Universal Testing Machine. A specimen of a film sample is cut to 3 in.×6 in. A B-type sled is used, which is a 2.5 in.×2.5 in. square and weighs 195 g. The sample is wrapped snugly around the sled with the machine direction (MD) aligned parallel to the direction of movement. This is aided by the use of double-sided tapes pre-attached onto the top face of the sled. Unless otherwise indicated, all samples are monolayer films, so either side of the film can be wrapped onto the sled. Furthermore, it is ensured that there are no wrinkles on the film surface to be tested. A COF measurement fixture, which consists of a rigid plate with a low-friction pulley, is attached to the fixed base of the equipment. A metal plate is then placed on top of the aforementioned rigid plate and is used subsequently as the plane on which is the sled is to be driven. The sled with the film specimen attached is then placed on the metal plane and attached to the nylon tow line, which goes around the pulley and attaches to the crosshead of the test frame. The crosshead is then driven at a speed of 6 in/min for a distance of 3 in. The force at which the sample starts to move (initial peak in the load-displacement data) is the static force (FS). The average force calculated between 0.5 in. and 3 in. of movement is the kinetic force (FK). The static COF, μS, is the ratio of the static force (FS) to the normal force (=weight of the sled, W). Similarly, the kinetic COF, μK, is the ratio of the kinetic force (FK) to the normal force. Five replicates are run for each sample and the average value is reported. Coefficient of friction is dimensionless. Reported COF is kinetic COF (interchangeably referred to as “dynamic COF”).

Density is measured in accordance with ASTM D792, Method B. Results are reported in grams per cubic centimeter (g/cc).

Improved Method for Comonomer Content Analysis (iCCD)

Improved method for comonomer content analysis (iCCD) was developed in 2015 (Cong and Parrott et al., WO2017040127A1). iCCD test was performed with Crystallization Elution Fractionation instrumentation (CEF) (PolymerChar, Spain) equipped with IR-5 detector (PolymerChar, Spain) and two angle light scattering detector Model 2040 (Precision Detectors, currently Agilent Technologies). Ortho-dichlorobenzene (ODCB, 99% anhydrous grade or technical grade) was used. Silica gel 40 (particle size 0.2^{˜}0.5 mm, catalogue number 10181-3) from EMD Chemicals was obtained (can be used to dry ODCB solvent before). The CEF instrument is equipped with an autosampler with N2 purging capability. ODCB is sparged with dried nitrogen (N2) for one hour before use. Sample preparation from films or pellets was done with an autosampler to a target concentration of 4 mg/mL (unless otherwise specified) under shaking at 160° C. for 1 hour. The injection volume was 300 μL. The temperature profile of iCCD was: crystallization at 3° C./min from 105° C. to 30° C., the thermal equilibrium at 30° C. for 2 minutes (including Soluble Fraction Elution Time being set as 2 minutes), elution at 3° C./min from 30° C. to 140° C. The flow rate during crystallization is 0.0 mL/min. The flow rate during elution is 0.50 mL/min. The data was collected at one data point/second.

The iCCD column was packed with gold coated nickel particles (Bright 7GNM8-NiS, Nippon Chemical Industrial Co.) in a 15 cm (length) X % in. (ID) stainless tubing. The column packing and conditioning were with a slurry method according to the reference (Cong, R.; Parrott, A.; Hollis, C.; Cheatham, M. WO2017040127A1). The final pressure with TCB slurry packing was 150 Bars.

Column temperature calibration was performed by using a mixture of the Reference Material Linear homopolymer polyethylene (having zero comonomer content, Melt index (12) of 1.0, polydispersity Mw/Mn approximately 2.6 by conventional gel permeation chromatography, 1.0 mg/mL) and Eicosane (2 mg/mL) in ODCB. iCCD temperature calibration consisted of four steps: (1) Calculating the delay volume defined as the temperature offset between the measured peak elution temperature of Eicosane minus 30.00° C.; (2) Subtracting the temperature offset of the elution temperature from iCCD raw temperature data. It is noted that this temperature offset is a function of experimental conditions, such as elution temperature, elution flow rate, etc.; (3) Creating a linear calibration line transforming the elution temperature across a range of 30.00° C. and 140.00° C. so that the linear homopolymer polyethylene reference had a peak temperature at 101.0° C., and Eicosane had a peak temperature of 30.0° C.; (4) For the soluble fraction measured isothermally at 30° C., the elution temperature below 30.0° C. is extrapolated linearly by using the elution heating rate of 3° C./min according to the reference (Cerk and Cong et al., U.S. Pat. No. 9,688,795).

The comonomer content versus elution temperature of iCCD was constructed by using 12 reference materials (ethylene homopolymer and ethylene-octene random copolymer made with single site metallocene catalyst, having ethylene equivalent weight average molecular weight ranging from 35,000 to 128,000 g/mol). All of these reference materials were analyzed same way as specified previously at 4 mg/mL. The reported elution peak temperatures followed the figure of octene mole % versus elution temperature of iCCD at R2 of 0.984.

Molecular weight of polymer and the molecular weight of the polymer fractions was determined directly from light scattering (LS) detector (90 degree angle) and concentration detector (IR-5) according Rayleigh-Gans-Debys approximation (Striegel and Yau, Modern Size Exclusion Liquid Chromatogram, Page 242 and Page 263) by assuming the form factor of 1 and all the virial coefficients equal to zero. Baselines were subtracted from LS, and concentration detector chromatograms. Integration windows are set to integrate all the chromatograms in the elution temperature (temperature calibration is specified above) range from 23.0 to 120° C.

The calculation of Molecular Weight (Mw) from iCCD includes the following steps:

Measuring the interdetector offset. The offset is defined as the geometric volume offset between LS with respect to concentration detector. It is calculated as the difference in the elution volume (mL) of polymer peak between concentration detector and LS chromatograms. It is converted to the temperature offset by using elution thermal rate and elution flow rate. A linear high density polyethylene (having zero comonomer content, Melt index (12) of 1.0, polydispersity Mw/Mn approximately 2.6 by conventional gel permeation chromatography) is used. Same experimental conditions as the normal iCCD method above are used except the following parameters: crystallization at 10° C./min from 140° C. to 137° C., the thermal equilibrium at 137° C. for 1 minute as Soluble Fraction Elution Time, soluble fraction (SF) time of 7 minutes, elution at 3° C./min from 137° C. to 142° C. The flow rate during crystallization is 0.0 mL/min. The flow rate during elution is 0.80 mL/min. Sample concentration is 1.0 mg/mL.

Each LS datapoint in LS chromatogram is shifted to correct for the interdetector offset before integration.

Baseline subtracted LS and concentration chromatograms are integrated for the whole eluting temperature range of the Step (1). The MW detector constant is calculated by using a known MW HDPE sample in the range of 100,000 to 140,000 Mw and the area ratio of the LS and concentration integrated signals.

Mw of the polymer was calculated by using the ratio of integrated light scattering detector (90 degree angle) to the concentration detector and using the MW detector constant. With the measured MW detector constant, NIST NBS 1475a analyzed with same method specified in (1) above gave molecular weight of 58,000 g/mol.

Instrumented Dart Impact (IDI). Instrumented dart impact (IDI) testing follows and is compliant with ASTM D7192. The film is conditioned for at least 40 hours at 23° C. (+/−2° C.) and 50% R.H (+/−10) as per ASTM standards. Standard testing conditions are 23° C. (+/−2° C.) and 50% R.H (+/−10) as per ASTM standards. The probe used is stainless steel, polished to a mirror finish, striking the film at 3.3 m/s. Force versus displacement curves, peak force, peak energy, displacement and total energy are reported. IDI energy results are reported in Joules (J).

Melt Index. The term “melt index,” or “MI” as used herein, refers to the measure of how easily a thermoplastic polymer flows when in a melted state. Melt index, or I₂, is measured in accordance by ASTM D 1238 Method A, Condition 190° C./2.16 kg, and is reported in grams eluted per 10 minutes (g/10 min). The 110 is measured in accordance with ASTM D 1238 Method A, Condition 190° C./10 kg, and is reported in grams eluted per 10 minutes (g/10 min). A melt flow rate ratio is calculated from these individual values by taking the ratio of 110 to 12. The melt flow rate ratio is dimensionless.

Puncture strength. The Puncture test determines the resistance of a film to the penetration of a probe at a standard low rate, single test velocity.

The film is conditioned for at least 40 hours at 23° C. (+/−2° C.) and 50% R.H (+/−10%) as per ASTM standards. Standard testing conditions are 23° C. (+/−2° C.) and 50% R.H (+/−10%) as per ASTM standards.

Puncture is measured on a tensile testing machine. Square specimens are cut from a sheet to a size of approximately 6 inches by 6 inches. The specimen is clamped in a 4-inch diameter circular specimen holder and a puncture probe is pushed into the center of the clamped film at a cross head speed of 10 inches/minute. The probe used is a 0.5-inch diameter polished steel ball on a 0.25 inch diameter support rod. A single thickness measurement is made in the center of the specimen. For each specimen, the maximum force, force at break, penetration distance, energy to break and puncture strength (energy per unit volume of the sample) is determined. A total of 5 specimens are tested to determine an average puncture value. The puncture probe is cleaned using a “Kim-wipe” after each specimen. Puncture values are reported in ft-lbf/in³.

2% Secant Modulus. Secant modulus was measured as described here. The film sample is conditioned per ASTM standards for at least 40 hours at 23° C. (±2° C.) and 50% R.H (±10%) before the test which is conducted at 23° C. (±2° C.) and 50% R.H (±10%) per ASTM standards. Film strips of dimension 1 in. wide by 8 in. long are cut from a film in the desired direction (machine (MD) and the cross directions (CD)). The specimens are loaded onto a tensile testing frame using line grip jaws (flat rubber on one side of the jaw and a line grip on the other) set at a gauge length of 4 in. The specimens are then strained at a crosshead speed of 2 in./min up to a nominal strain of 5%. The secant modulus is measured at a specified strain and is the ratio of the stress at the specified strain to the specified strain, as determined from the load—extension curve. Typically, secant modulus at 1% and 2% strain are calculated. Five replicates are typically tested for each sample. Secant moduli results are reported in ksi (1000 psi).

Tear-machine direction (MD) and cross direction (CD). The Elmendorf Tear test determines of the average force to propagate tearing through a specified length of plastic film or nonrigid sheeting after the tear has been started, using an Elmendorf-type tearing tester.

The film is conditioned for at least 40 hours at 23° C. (+/−2° C.) and 50% R.H (+/−10%) as per ASTM standards. Standard testing conditions are 23° C. (+/−2° C.) and 50% R.H (+/−10%) as per ASTM standards.

The force in grams required to propagate tearing across a film or sheeting specimen is measured using a precisely calibrated pendulum device. Acting by gravity, the pendulum swings through an arc, tearing the specimen from a precut slit. The specimen is held on one side by the pendulum and on the other side by a stationary member. The loss in energy by the pendulum is indicated by a pointer or by an electronic scale. The scale indication is a function of the force required to tear the specimen. The sample used is the ‘constant radius geometry’ as specified in D1922. Testing would be typically carried out on samples that have been cut from both the MD and CD directions. Prior to testing, the sample thickness is measured at the sample center. A total of 15 specimens per direction are tested and average tear strength reported. Samples that tear at an angle greater than 60° from the vertical are described as ‘oblique’ tears—such tears should be noted, though the strength values are included in the average strength calculation. Tear resistance results are reported in gf.

Triple Detection Gel Permeation Chromatography (TDGPC). The chromatographic system consisted of a PolymerChar GPC-IR (Valencia, Spain) high temperature GPC chromatograph equipped with an internal IR5 infra-red detector (IR5) and 4-capillary viscometer (DV) coupled to a Precision Detectors (Now Agilent Technologies) 2-angle laser light scattering (LS) detector Model 2040. For all absolute light scattering measurements, the 15 degree angle is used for measurement. The autosampler oven compartment was set at 160° Celsius and the column and detector compartment were set at 150° Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flowrate (FR) was 1.0 milliliters/minute.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein pellet or film samples were weight-targeted at 2 mg/mL, and the solvent (containing 200 ppm BHT) was added to a pre nitrogen-sparged septa-capped vial, via the PolymerChar high temperature autosampler. The samples were dissolved for 2 hours at 160° Celsius under “low speed” shaking.

In order to monitor the deviations over time, a flowrate marker (decane) was introduced into each sample via a micropump controlled with the PolymerChar GPC-IR system. This flowrate marker (FM) was used to linearly correct the pump flowrate (FR_{Nominal}) for each sample by Retention Volume (RV) alignment of the respective decane peak within the sample (RV_{FM Sample}) to that of the decane peak within the narrow standards calibration (RV_{FM Calibrated}). Any changes in the time of the decane marker peak are then assumed to be related to a linear-shift in flowrate (FR_{Effective}) for the entire run. After calibrating the system based on a flow marker peak, the effective flowrate (with respect to the narrow standards calibration) is calculated as Equation 1. Processing of the flow marker peak was done via the PolymerChar GPCOne™ Software. Acceptable flowrate correction is such that the effective flowrate should be within +/−0.5% of the nominal flowrate.

$${FR}_{Effective} = {FR}_{Nominal} \times ( {RV}_{FM Calibrated} / {RV}_{FM Sample} ) \qquad ( EQ1 )$$

For the determination of the viscometer and light scattering detector offsets from the IR5 detector, the Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log molecular weight and intrinsic viscosity results from a linear homopolymer polyethylene reference (3.5>M_{w}/Mₙ>2.2) with a molecular weight in the range of 115,000 to 125,000 g/mol to the narrow standard column calibration results from the narrow standards calibration curve using PolymerChar GPCOne™ Software.

The absolute molecular weight data was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of −0.104 mL/g. Generally, the mass detector response (IR5) and the light scattering constant (determined using GPCOne™) should be determined from a linear homopolymer polyethylene reference (3.5>M_{w}/Mₙ>2.2) with a molecular weight in the range of 115,000 to 125,000 g/mol. The viscometer calibration (determined using GPCOne™) can be accomplished using the methods described by the manufacturer, or, alternatively, by using the published values of suitable linear standards, such as Standard Reference Materials (SRM) 1475 (available from National Institute of Standards and Technology (NIST)). A viscometer constant (obtained using GPCOne™) is calculated which relates specific viscosity area and injected mass for the calibration standard to its intrinsic viscosity. The chromatographic concentrations are assumed low enough to eliminate addressing 2nd viral coefficient effects (concentration effects on molecular weight).

The absolute molecular weight (Mᵢ), at each chromatographic slice, is obtained (using GPCOne™) from the Area of the Light Scattering (LS) integrated chromatogram (factored by the light scattering constant) divided by the mass recovered from the mass constant and the mass detector (IR5) area taken from the baseline-subtracted IR chromatogram at each equally spaced data collection point (IRᵢ). The Mᵢ and intrinsic viscosity (IVᵢ) values are linearly extrapolated at chromatographic ends where signal to noise becomes low (using GPCOne™) but the extrapolation must be performed so that EQ3 is equal to bulk molecular weight by light scattering (Ortin, A., Lopez, E., Hierro, P., Sancho-Tello, J., Yau., W., Macromol. Symp., 377, 1700044 (2018)). Absolute molecular weight moments from light scattering, Mₙ, M_{w} and M_{z} are calculated as follows:

$${M}_{n} = \frac{{\sum }_{i = 0}^{n} {IR}_{i}}{{\sum }_{i = 0}^{n} ( {IR}_{i} / {M}_{i} )} \qquad ( EQ 2 )$$

$${M}_{w} = \frac{{\sum }_{i = 0}^{n} {IR}_{i} \times {M}_{i}}{{\sum }_{i = 0}^{n} {IR}_{i}} \qquad ( EQ 3 )$$

$${M}_{z} = \frac{{\sum }_{i = 0}^{n} {IR}_{i} \times {M}_{i}^{2}}{{\sum }_{i = 0}^{n} {IR}_{i} \times {M}_{i}} \qquad ( EQ 4 )$$

Calculation of LCB frequency (LCBf). The long chain branching frequency was calculated based on the differences between the g′, which is a ratio of the intrinsic viscosity of a polymer sample over a linear polymer reference with the same molecular weight. In TDGPC practice, a reference polyethylene homopolymer, containing no detectable LCB or SCB, and with a Mw of approximately 120,000 g/mol and polydispersity around 3.0, is injected at the beginning of each run queue to establish the Mark-Houwink linear reference line. A first-order linear fit is applied to the obtained log of the intrinsic viscosity and log of the molecular weight data within the log of the molecular weight range of 4.5 to 5.8 g/mol to provide the linear reference K and a values.

A polyethylene sample of interest is analyzed to obtain intrinsic viscosity, molecular weight values, and the value of g′ is calculated at each chromatographic slice (i) according to Equation 5:

$${g}_{i}^{′} = ( {IV}_{Sample , i} / {IV}_{linear reference , i} ) , \qquad ( Eq . 5 )$$

where the calculation utilizes the IV_{sample,i} at equivalent absolute molecular weight values and same SCB content values to the linear reference within the log molecular weight range of 4.5 to 5.8 g/mol. If a difference in SCB content exists, the IV_{linear reference,i} line is vertically shifted by adjusting the K value from the Mark-Houwink Plot to account for the SCB correction compared to the IV_{sample,i}. The shift is done until the linear reference line makes a single point of contact to make a tangent with the sample Mark-Houwink line at a log molecular weight of 4.5.

A Zimm-Stockmayer branching factor g was calculated from g′, g′=g^{e}, using an epsilon factor of 0.5. The number of branches along the polymer sample (Bₙ) at each data slice (i) can be determined by using Equation 6, (B. H. Zimm and W. H. Stockmayer, J. Chem. Phys. 17, 1301 (1949)):

$$g = {[ {( 1 + \frac{{B}_{n , i}}{7} )}^{1 / 2} + \frac{4}{9} \frac{{B}_{n , i}}{π} ]}^{- 1 / 2} . \qquad ( Eq . 6 )$$

Finally, the average LCBf quantity per 1000 carbons in the polymer across all of the slices (i) can be determined using Equation 7:

$$LCBf = \frac{{\sum }^{i} ( \frac{{B}_{n , i}}{{M}_{i} / 14000} {c}_{i} )}{\sum {c}_{i}} . \qquad ( Eq . 7 )$$

TDGPC and Absolute Molecular Weighted Short Chain Branching Distribution Index (M-SCBDI). A calibration for the IR5 detector rationing was performed using at least ten ethylene-based polymer references (Octene as comonomer) made by single-site metallocene catalyst from a single reactor in solution process (polyethylene homopolymer and ethylene/octene copolymers) of a narrow short chain branching (SCB) distribution and known comonomer content (as measured by ¹³C NMR Method, Qiu et al., Anal. Chem. 2009, 81, 8585-8589), ranging from homopolymer (0 SCB/1000 total C) to approximately 40 SCB/1000 total C, where total C=carbons in backbone+carbons in branches (Cong, R., deGroot, W., Parrott, A., Yau, W., Hazlitt, L., Brown, R., Miller, M., Zhou, Z., Macromolecules, 44, 3062-3072 (2011)). Each reference had a weight-average molecular weight from 36,000 g/mole to 126,000 g/mole measured by GPC and a molecular weight distribution (M_{w}/Mₙ) from 2.0 to 2.5 (Karjala, T., Sammler, R., Mangnus, M., Hazlitt, L., Johnson, M., Wang, J., Hagen, C., Huang, J., Reichek, K., J. Appl. Polym. Sci., 119, 636-646 (2011)). Polymer properties for the SCB standards are shown in Table A.

TABLE A
“SCB” Standards

| Wt % Comonomer | SCB/1000 Total C | M_{w} | M_{w}/Mₙ |
|---|---|---|---|
| 23.1 | 28.9 | 37,300 | 2.22 |
| 14.0 | 17.5 | 36,000 | 2.19 |
| 0.0 | 0.0 | 38,400 | 2.20 |
| 35.9 | 44.9 | 42,200 | 2.18 |
| 5.4 | 6.8 | 37,400 | 2.16 |
| 8.6 | 10.8 | 36,800 | 2.20 |
| 39.2 | 49.0 | 125,600 | 2.22 |
| 1.1 | 1.4 | 107,000 | 2.09 |
| 14.3 | 17.9 | 103,600 | 2.20 |
| 9.4 | 11.8 | 103,200 | 2.26 |

The “IR5 Area Ratio (or “IR5_{Methyl Channel Area}/IR5_{Measurement Channel Area}”)” of “the baseline-subtracted area response of the IR5 methyl channel sensor” to “the baseline-subtracted area response of IR5 measurement channel sensor” (standard filters and filter wheel as supplied by PolymerChar: Part Number IR5_FWM01 included as part of the GPC-IR instrument) was calculated for each of the “SCB” standards. A linear fit of the SCB frequency versus the “IR5 Area Ratio” was constructed in the form of the following Equation 8:

$$SCB / 1000 Total C = {A}_{0} + [ {A}_{1} \times ( {IR 5}_{Methyl Channel Area} / {IR 5}_{Measurement Channel Area} ) ] \qquad ( EQ 8 )$$

where A₀ is the “SCB/1000 Total C” intercept at an “IR5 Area Ratio” of zero, and A₁ is the slope of the “SCB/1000 Total C” versus “IR5 Area Ratio” and represents the increase in the SCB/1000 Total C as a function of “IR5 Area Ratio.” The IR5 area ratio is equal to the IR5 height ratio for narrow PDI and narrow SCBD standard materials.

“A series of linear baseline-subtracted chromatographic heights” for the chromatogram generated by the “IR5 methyl channel sensor” was established as a function of column elution volume, to generate a baseline-corrected chromatogram (methyl channel). “A series of linear baseline-subtracted chromatographic heights” for the chromatogram generated by the “IR5 measurement channel” was established as a function of column elution volume, to generate a base-line-corrected chromatogram (measurement channel).

The “IR5 Height Ratio” of “the baseline-corrected chromatogram (methyl channel)” to “the baseline-corrected chromatogram (measurement channel)” was calculated at each column elution volume index (each equally-spaced index, representing 1 data point per second at 1 ml/min elution flow rate) across the sample integration bounds. The “IR5 Height Ratio” was multiplied by the coefficient A₁, and the coefficient A₀ was added to this result, to produce the predicted SCB frequency of the sample.

The comonomer composition values are thus reported as octene comonomer equivalent SCB/1000 Total C at each index i and are plotted as a function of absolute molecular weight at the corresponding i indices (Mᵢ). The absolute molecular weight values from light scattering, are also plotted as a molecular weight distribution of dWf/d Log(Mᵢ) vs Log(Mᵢ) where the increments in Log(Mᵢ) were 0.01. Hence, two distributions are defined.

The absolute molecular weight values from light scattering are obtained from a light scattering detector with at a minimum signal/noise ratio (S/N) of 300. The S/N is defined as:

$$S / N = \frac{( {LS}_{Peak Max} - {LS}_{Baseline} )}{{LS}_{Noise}} \qquad ( EQ 9 )$$

where LS_{Peak Max} is the maximum light scattering signal located at the polymer peak, LS_{Baseline} is the mean of consecutive, equally-spaced baseline data points that elute prior to the polymer peak, and consist of at least 10% of the length of the entire GPC run time, and the LS_{Noise} is the standard deviation of the same data array used in the LS_{Baseline} calculation.

The comonomer distribution of SCB/1000 Total C (function of Log(Mᵢ)) was split into two sections, a high and a low molecular weight region. The regions were defined around the maximum peak value of the SCB/1000 Total C distribution (SCB/1000C Peak) and its corresponding Log(Mᵢ) value, denoted as the Log(M_{SCB Peak}).

Log(Mᵢ) values in the range of [Log(M_{SCB Peak})+0.1] to [Log(M_{SCB Peak})+0.6] define the “high Log M_{range}”, namely a 0.5 Log M region above Log(M_{SCB Peak}) for the calculation of the High Absolute Molecular Weight SCB Distribution Index (high M-SCBDI). Calculation of the high M-SCBDI value require at least 51 non-zero data points equally spaced by 0.01 increments in the x-coordinate. An EXCEL linear regression function (LINEST) performed on corresponding SCB/1000 Total C (y-axis) and Log(Mᵢ) (x-axis) values within this bounded range produced a slope value defined to be the high M-SCBDI value.

Log(Mᵢ) values in the range of [Log(M_{SCB Peak})−0.6] to [Log(M_{SCB Peak})−0.1] define the “low Log M_{range}”, namely a 0.5 Log M region below Log(M_{SCB Peak}) for the calculation of the Low Absolute Molecular Weight SCB Distribution Index (low M-SCBDI). Calculation of the low M-SCBDI value require at least 51 non-zero data points equally spaced by 0.01 increments in the x-coordinate. An EXCEL linear regression function (LINEST)SCB/1000 Total C (y-axis) and Log(Mᵢ) (x-axis) values within this bounded range produced a slope value defined to be the low M-SCBDI value.

Without the minimum requisite for non-zero Log(Mᵢ) values in the high or low Log M_{range} above or below the Log(M_{SCB Peak}) value, the LINEST fit cannot be applied to calculate M-SCBDI. Furthermore, to ensure quality data, all of the SCB/1000C values used in the calculation must exceed 4.0 so that false peaks are not identified from low signal/noise data. In addition, all of the Log(Mᵢ) values used in the linear regression for the low and high M-SCBDI calculation, must have corresponding dWf/d Log M values from the absolute molecular weight distribution that are greater than 10% of the maximum dWf/d Log M value (i.e., dWf/Log Mₚ) located at the peak of the curve (Log Mₚ).

### DETAILED DESCRIPTION

The present disclosure provides a polyethylene composition. In an embodiment, the polyethylene composition includes (A) at least 25 wt % of a high density polyethylene having (i) a density from 0.950 to 0.970 g/cm³, (ii) a melt index (I₂) from 0.2 g/10 minutes to 2.0 g/10 minutes, and (iii) a molecular weight distribution (M_{w(abs)}/M_{n(abs)}) from greater than 4.0 to 30.0. The polyethylene composition also includes (B) a polyethylene enhancer that is an ethylene/C₄-C₈ α-olefin copolymer having (i) a density from 0.880 g/cm³ to 0.910 g/cm³, (ii) a melt index from 0.2 g/10 minutes to 2.0 g/10 minutes, and (iii) a LCBf/1000C value less than 0.015. The polyethylene composition has (1) a density from 0.915 g/cm³ to 0.925 g/cm³, (2) a melt index (I₂) from 0.3 g/10 minutes to 2.0 g/10 minutes, (3) Mw(abs)/Mn(abs) value from 5.0 to 11.0, (4) a low M-SCBDI value from 9.0 to 25.0, (5) a high M-SCBDI value from −8.0 to −12.0, (6) a first polyethylene fraction having (a) at least one peak in a temperature range from 40° C. to 79° C., and (b) an average M_{w} from 100,000 g/mol to 200,000 g/mol on an elution profile via improved comonomer composition distribution (iCCD) analysis method, (7) a second polyethylene fraction having (a) at least one peak in a temperature range from 80° C. to 120° C., and (b) an average M_{w} from 90,000 g/mol to 250,000 g/mol on the elution profile via improved iCCD analysis method, and (8) a ratio of the average M_{w} of the first polyethylene fraction to the average M_{w} of the second polyethylene fraction from 0.6 to 1.2.

The present polyethylene composition includes (A) at least 25 wt % of a high density polyethylene. A “high density polyethylene,” as used herein is an ethylene homopolymer or an ethylene/C₄-C₈ α-olefin copolymer having a density from 0.95 g/cc to 0.97 g/cc, a melt index from 0.2 g/10 min to 2.0 g/10 min and a (iii) a M_{w(abs)}/M_{n(abs)}) from greater than 4.0 to 30.0.

In an embodiment the high density polyethylene has
(i) a density from 0.950 g/cc to 0.970 g/cc, or from 0.955 g/cc to 0.970 g/cc;
(ii) a melt index from 0.2 g/10 min to 2.0 g/10 min, or from 0.3 g/10 min to 1.2 g/10 min; and
(iii) an M_{w(abs)}/M_{n(abs)} from greater than 4.0 to 30.0, or from 4.2 to 30.0, or from 4.5 to 25.0, or from 5.0 to 23.0. Nonlimiting examples of high density polyethylene are disclosed in WO2021/076357 and WO2021/242384, the contents of each incorporated by reference herein.

In an embodiment, the high density polyethylene is a high density polyethylene post-consumer resin, or “HDPE-PCR.” The term “post-consumer resin” (or “PCR”) refers to a polymeric material that has been previously used as consumer packaging or industrial packaging. In other words, PCR is waste plastic. PCR is typically collected from recycling programs and recycling plants. PCR typically requires additional cleaning and/or processing before it can be re-introduced into a manufacturing line. The PCR may include one or more of an ethylene-based polymer, a propylene-based polymer, a polyester, a poly(vinyl chloride), a polystyrene, an acrylonitrile butadiene styrene, a polyamide, an ethylene vinyl alcohol, an ethylene vinyl acetate, or a poly-vinyl chloride. The PCR may include one or more contaminants. The contaminants may be the result of the polymeric material's use prior to being repurposed for reuse. In some embodiments, contaminants may include paper, ink, food residue, or other recycled materials in addition to the polymer, which may result from the recycling process. It is understood PCR is different from post-industrial recycle (PIR) resin in that the latter has not reached consumer. It is understood that similar principles described herein for PCR would also apply to PIR resins.

PCR is distinct from virgin polymeric material. Since PCR has gone through an initial heat and molding process; PCR is not “virgin” polymeric material. A “virgin polymeric material” is a polymeric material that has not undergone, or otherwise has not been subject to, a heat process or a molding process other than those related to the initial manufacture of pellets or granules. The physical, chemical and flow properties of PCR resin differ when compared to virgin polymeric resin.

The PCR is a high density polyethylene-PCR (“HDPE-PCR”). Nonlimiting examples of sources for HDPE-PCR include rigid HDPE packaging such as bottles (milk jugs, juice containers), and flexible HDPE packaging such as stand-up pouches and t-shirt bags. HDPE-PCR also includes residue from its original use, residue such as paper, adhesive, ink, ethylene vinyl alcohol (EVOH), polyamide (PA), polyethylene terephthalate (PET), and other odor causing agents. The HDPE-PCR has:
(i) a density from 0.950 g/cc to 0.970 g/cc, or from 0.955 g/cc to 0.970 g/cc;
(ii) a melt index from 0.2 g/10 min to 2.0 g/10 min, or from 0.3 g/10 min to 1.2 g/10 min; and
(iii) an M_{w(abs)}/M_{n(abs)}) from greater than 4.0 to 30.0, or from 4.2 to 30.0, or from 4.5 to 25.0, or from 5.0 to 23.0.

Nonlimiting examples of suitable HDPE-PCR include PCR sold by Envision Plastics, North Carolina, USA, under the names EcoPrime™, PRISMA™, Natural HDPE PCR Resins, Mixed Color and Black HDPE PCR Resins; PCR sold by KW Plastics, Alabama, USA under the following names KWR101-150, KWR102-8812 BLK, KWR102, KWR105-7525, KWR-105M2, and KWR105M4.

The polyethylene composition includes (B) a polyethylene enhancer. A “polyethylene enhancer,” as used herein, is an ethylene-based polymer from the group of single-site catalyzed linear low density polyethylene, including both linear and substantially linear low density resins (m-LLDPE); ethylene-based plastomers (POP) and ethylene-based elastomers (POE). The polyethylene enhancer is an ethylene/C₄-C₈ α-olefin copolymer having (i) a density from 0.880 g/cm³ to 0.910 g/cm³, a (ii) a melt index from 0.2 g/10 minutes to 2.0 g/10 minutes, and (iii) a LCBf/1000C value less than 0.015.

In an embodiment, the polyethylene composition is composed of
(A) at least 25 wt % of the high density polyethylene having
(i) a density from 0.950 g/cc to 0.970 g/cc, or from 0.955 g/cc to 0.970 g/cc;
(ii) a melt index from 0.2 g/10 min to 2.0 g/10 min, or from 0.3 g/10 min to 1.2 g/10 min; and
(iii) an M_{w(abs)}/M_{n(abs)}) from greater than 4.0 to 30.0, or from 4.2 to 30.0, or from 4.5 to 25.0, or from 5.0 to 23.0 and
(B) the polyethylene enhancer is an ethylene/C₄-C₈ α-olefin copolymer having
(i) a density from 0.880 g/cm³ to 0.910 g/cm³, and
(ii) a melt index from 0.2 to 2.0 g/10 minutes, and
(iii) a LCBf/1000C value less than 0.015, and
the polyethylene composition has
(1) a density from 0.915 g/cm³ to 0.925 g/cm³,
(2) a melt index (I₂) from 0.3 g/10 minutes to 1.0 g/10 minutes,
(3) a Mw(abs)/Mn(abs) value from 5.0 to 11.0,
(4) a low M-SCBDI value from 9.0 to 25.0,
(5) a high M-SCBDI value from −8.0 to −12.0,
(6) a first polyethylene fraction having
   (a) at least one peak in a temperature range from 40° C. to 79° C., and
   (b) an average Mw from 100,000 g/mol to 200,000 g/mol on an elution profile via improved comonomer composition distribution (iCCD) analysis method,
(7) a second polyethylene fraction having
   (a) at least one peak in a temperature range from 80° C. and 120° C., and
   (b) an average M_{w} from 90,000 g/mol to 250,000 g/mol on the elution profile via improved iCCD analysis method, and
(8) a ratio of the average M_{w} of the first polyethylene fraction to the average M_{w} of the second polyethylene fraction from 0.6 to 1.2.

The polyethylene composition has a density from 0.915 g/cm³ to 0.925 g/cm³, a melt index (I₂) from 0.3 g/10 minutes to 2.0 g/10 minutes, and a Mw(abs)/Mn(abs) value from 5.0 to 11.0.

The polyethylene composition has a low M-SCBDI value from 9.0 to 25.0, and a high M-SCBDI value from −8.0 to −12.0.

The polyethylene composition has a first polyethylene fraction and a second polyethylene fraction. A polyethylene “fraction” refers to a portion of the total polyethylene composition. The first polyethylene fraction and the second polyethylene fraction each is quantified by its respective temperature range in an elution profile via improved comonomer composition distribution (iCCD) analysis method (hereafter interchangeably referred to as “iCCD.”).

The first polyethylene fraction is located in a first polyethylene fraction area defined by a temperature range from 40° C. to 79° C. in the elution profile via iCCD. The second polyethylene fraction is located in a second polyethylene fraction area defined by a temperature range from 80° C. to 120° C. in the elution profile via iCCD. In an embodiment, the first polyethylene fraction area is the area in the iCCD elution profile between 40° C. to 79° C. beneath a single peak of the first polyethylene fraction, the first polyethylene fraction having an average M_{w} from 100,000 g/mol to 200,000 g/mol, or from 100,000 g/mol to 150,000 g/mol and the second polyethylene fraction area is the area in the iCCD elution profile between 80° C. to 120° C. beneath a single peak of the second polyethylene fraction, the second polyethylene fraction having an average M_{w} from 90,000 g/mol to 250,000 g/mol, or from 90,000 g/mol to 180,000 g/mol. Each peak includes an upward sloping region followed by a downward sloping region to form each respective single peak. The polyethylene composition has a ratio of the average M_{w} of the first polyethylene fraction to the average M_{w} of the second polyethylene fraction from 0.4 to 1.4, or from 0.6 to 1.3, or from 0.7 to less than 1.0.

In an embodiment, the polyethylene composition includes
(A) from 25 wt % to 75 wt %, or from 30 wt % to 60 wt %, or from 30 wt % to 40 wt %, or from 31 wt % to 36 wt % of the high density polyethylene, the high density polyethylene having
   (i) a density from 0.950 g/cm³ to 0.970 g/cm³, or from 0.955 g/cm³ to 0.970 g/cm³,
   (ii) a melt index from 0.2 g/10 min to 2.0 g/10 min, or from 0.3 g/10 min to 1.0 g/10 minutes
   (iii) a molecular weight distribution (M_{w(abs)}/M_{n(abs)}) from greater than 4.0 to 30.0, or from greater than 6.0 to 25;
   (B) from 75 wt % to 25 wt %, or from 70 wt % to 40 wt %, or from 70 wt % to 60 wt %, or from 69 wt % to 64 wt % of the polyethylene enhancer, the polyethylene enhancer is an ethylene/C₄-C₈ α-olefin copolymer having
   (i) a density from 0.880 g/cm³ to 0.910 g/cm³, or from 0.880 g/cm³ to less than 0.900 g/cm³,
   (ii) a melt index from 0.2 g/10 minutes to 2.0 g/10 minutes, or from 0.3 g/10 minutes to 1.0 g/10 minutes, or from 0.4 g/10 minutes to 0.9 g/10 minutes,
   (iii) LCBf/1000C value less than 0.020, or from 0.001 to 0.020, or from 0.001 to 0.015, or from 0.001 to 0.010, and
the polyethylene composition has
(1) a density from 0.915 g/cm³ to 0.925 g/cm³, or 0.918 g/cm³ to 0.921 g/cm³,
(2) a melt index (I₂) from 0.3 g/10 minutes to 1.0 g/10 minutes, or from 0.35 g/10 minutes to 0.9 g/10 minutes,
(3) a Mw(abs)/Mn(abs) value from 5.0 to 11.0,
(4) a low M-SCBDI value from 9.0 to 25.0,
(5) a high M-SCBDI value from −8.0 to −12.0,
(6) a first polyethylene fraction in the iCCD having
   (a) a single peak in a temperature range from 40° C. to 79° C., and
   (b) an average M_{w} from 100,000 g/mol to 200,000 g/mol, or from 100,000 g/mol to 150,000 g/mol, or from 110,000 g/mol to 130,000 g/mol,
(7) a second polyethylene fraction in the iCCD having
   (a) a single peak in a temperature range from 80° C. and 120° C., and
   (b) an average M_{w} from 90,000 g/mol to 250,000 g/mol, or from 90,000 g/mol to 180,000 g/mol, or from 100,000 g/mol to 160,000 g/mol, and
(8) a ratio of the average M_{w} of the first polyethylene fraction to the average M_{w} of the second polyethylene fraction from 0.4 to 1.4, or from 0.6 to 1.3, or from 0.7 to less than 1.0 (hereafter interchangeably referred to as “composition 1”).

The polyethylene composition may include one or more optional additives. Nonlimiting examples of suitable additives include, but are not limited to, antistatic agents, color enhancers, dyes, lubricants, fillers (for example, TiO₂ or CaCO₃), opacifiers, nucleators, processing aids, pigments, primary antioxidants, secondary anti-oxidants, UV stabilizers, anti-blocks, slip agents, tackifiers, fire retardants, anti-microbial agents, odor reducer agents, anti-fungal agents, and combinations thereof. The present polyethylene composition may include from 0.001 to 10 weight (wt) percent, or from 0.01 wt % to 1 wt %, or from 0.1 wt % to 0.5 wt %, by the combined weight of such additives, based on the total weight of the polyethylene composition including such additives.

The present disclosure provides a film. In an embodiment, the film is composed of the polyethylene composition. The polyethylene composition composed of
(A) at least 25 wt % of the high density polyethylene having
(i) a density from 0.950 g/cc to 0.970 g/cc, or from 0.955 g/cc to 0.970 g/cc;
(ii) a melt index from 0.2 g/10 min to 2.0 g/10 min, or from 0.3 g/10 min to 1.2 g/10 min; and
(iii) an M_{w(abs)}/M_{n(abs)}) from greater than 4.0 to 30.0, or from 4.2 to 30.0, or from 4.5 to 25.0, or from 5.0 to 23.0 and
(B) the polyethylene enhancer is an ethylene/C₄-C₈ α-olefin copolymer having
(i) a density from 0.880 g/cm³ to 0.910 g/cm³, and
(ii) a melt index from 0.2 to 2.0 g/10 minutes, and
(iii) LCBf/1000C value less than 0.015, and the polyethylene composition has
(1) a density from 0.915 g/cm³ to 0.925 g/cm³,
(2) a melt index (I₂) from 0.3 g/10 minutes to 2.0 g/10 minutes,
(3) a Mw(abs)/Mn(abs) value from 5.0 to 11.0,
(4) a low M-SCBDI value from 9.0 to 25.0,
(5) a high M-SCBDI value from −8.0 to −12.0,
(6) a first polyethylene fraction having
   (a) at least one peak in a temperature range from 40° C. to 79° C., and
   (b) an average M_{w} from 100,000 g/mol to 200,000 g/mol on an elution profile via improved comonomer composition distribution (iCCD) analysis method,
(7) a second polyethylene fraction having
   (a) at least one peak in a temperature range from 80° C. and 120° C., and
   (b) an average M_{w} from 90,000 g/mol to 250,000 g/mol on the elution profile via improved iCCD analysis method, and
(8) a ratio of the average M_{w} of the first polyethylene fraction to the average M_{w} of the second polyethylene fraction from 0.6 to 1.2.

In an embodiment, the film is composed of composition 1.

The film is a blown film or a cast film. The film is a monolayer film, or one or more layers in a multilayer film.

In an embodiment, the film is a monolayer film.

In an embodiment, the film is a layer in a multilayer film. The multilayer film can have 2, or 3, or 4, or 5, or 6, or 7, or 8, or 9, or 10, or 11 layers.

Films of the present disclosure can have a variety of thicknesses. In an embodiment, the film is a blown film and the blown film has a thickness from 0.25 mils, or 0.5 mils, or 0.7 mils, or 1.0 mil, or 1.75 mils, or 2.0 mils to 4.0 mils, or 6.0 mils, or 8.0 mils, or 10 mils, or 15 mils.

It is understood that any of the foregoing films/layers can further include one or more additives. Nonlimiting examples of suitable additives include antioxidants, ultraviolet light stabilizers, thermal stabilizers, slip agents, antiblock, pigments or colorants, processing aids, crosslinking catalysts, flame retardants, fillers and foaming agents. In an embodiment, the film includes 0 wt %, or greater than 0 wt %, or 1 wt %, to 1.5 wt %, or 2 wt %, or 2.5 wt %, or 3 wt % total additives based on total weight of the film.

In an embodiment, the film includes a layer formed from the present polyethylene composition that is laminated to another film.

The present film can be corona treated and/or printed (e.g., reverse or surface printed).

In an embodiment, the present film is oriented, uniaxially (e.g., in the machine direction) or biaxially (e.g., in the machine direction and in the cross direction).

In an embodiment, the film has a thickness from 1.5 mils to 2.5 mils, or from 1.7 mils to 2.3 mils. The film is composed of the polyethylene composition.

In an embodiment, the film is composed of the polyethylene composition. The polyethylene composition includes
(A) from 25 wt % to 75 wt %, or from 30 wt % to 60 wt %, or from 30 wt % to 40 wt %, or from 31 wt % to 36 wt % of the high density polyethylene, the high density polyethylene having
(i) a density from 0.950 g/cm³ to 0.970 g/cm³, or from 0.955 g/cm³ to 0.970 g/cm³,
(ii) a melt index from 0.2 g/10 min to 2.0 g/10 min, or from 0.3 g/10 min to 1.0 g/10 minutes
(iii) a molecular weight distribution (M_{w(abs)}/M_{n(abs)}) from greater than 4.0 to 30.0, or from greater than 6.0 to 25;
(B) from 75 wt % to 25 wt %, or from 70 wt % to 40 wt %, or from 70 wt % to 60 wt %, or from 69 wt % to 64 wt % of the polyethylene enhancer, the polyethylene enhancer is an ethylene/C₄-C₈ α-olefin copolymer having
(i) a density from 0.880 g/cm³ to 0.910 g/cm³, or from 0.880 g/cm³ to less than 0.900 g/cm³,
(ii) a melt index from 0.2 g/10 minutes to 2.0 g/10 minutes, or from 0.3 g/10 minutes to 1.0 g/10 minutes, or from 0.4 g/10 minutes to 0.9 g/10 minutes,
(iii) LCBf/1000C value less than 0.020, or from 0.001 to 0.020, or from 0.001 to 0.015, or from 0.001 to 0.010, and the polyethylene composition has
(1) a density from 0.915 g/cm³ to 0.925 g/cm³, or 0.918 g/cm³ to 0.921 g/cm³,
(2) a melt index (I₂) from 0.3 g/10 minutes to 1.0 g/10 minutes, or from 0.35 g/10 minutes to 0.9 g/10 minutes,
(3) a Mw(abs)/Mn(abs) value from 5.0 to 11.0,
(4) a low M-SCBDI value from 9.0 to 25.0,
(5) a high M-SCBDI value from −8.0 to −12.0,
(6) a first polyethylene fraction in the iCCD having
   (a) a single peak in a temperature range from 40° C. to 79° C., and
   (b) an average M_{w} from 100,000 g/mol to 200,000 g/mol, or from 100,000 g/mol to 150,000 g/mol, or from 110,000 g/mol to 130,000 g/mol,
(7) a second polyethylene fraction in the iCCD having
   (a) a single peak in a temperature range from 80° C. and 120° C., and
   (b) an average M_{w} from 90,000 g/mol to 250,000 g/mol, or from 90,000 g/mol to 180,000 g/mol, or from 100,000 g/mol to 160,000 g/mol, and
(8) a ratio of the average M_{w} of the first polyethylene fraction to the average M_{w} of the second polyethylene fraction is from 0.4 to 1.4, or from 0.6 to 1.3, or from 0.7 to less than 1.0, and
the film has one, some, or all of the following properties:
(i) an Instrumented Dart Impact energy from 2.5 J to 6 J; and/or
(ii) a machine direction tear strength from 400 gf to 800 gf; and/or
(iii) a cross direction tear strength from 800 gf to 1300 gf; and/or
(iv) a puncture resistance from 90 ft-lbf/in³ to 190 ft-lbf/in³; and/or
(v) a machine direction 2% modulus from 37 ksi to 41 ksi; and/or
(vi) a cross direction 2% modulus from 41 ksi to 44 ksi; and/or
(vii) a kinetic coefficient of friction from 0.5 to 0.65.

By way of example, and not limitation, some embodiments of the present disclosure will now be described in detail in the following Examples.

### EXAMPLES

Materials used in the comparative samples (CS) and in the inventive examples (IE) are provided in Tables 1A and 1B below.

TABLE 1A
Relevant properties for reference resins

| | | | | | | Mw(abs)/ | |
|---|---|---|---|---|---|---|---|
| | | Density | Melt index, | Mn(abs) | Mw(abs) | Mn(abs) | |
| Material | Properties | [g/cc] | I₂ [dg/min] | [g/mol] | [g/mol] | [—] | Source |
| LLD Ref 1 | DFDA 7047 | 0.918 | 1.0 | 22,515 | 128,007 | 5.69 | Dow, Inc. |
| LLD Ref 2 | Dowlex 2045G | 0.920 | 1.0 | 28,056 | 118,216 | 4.21 | Dow, Inc |
| LLD Ref 3 | Innate ST50 | 0.918 | 0.85 | 23,384 | 114,642 | 4.90 | Dow, Inc. |

### A. High Density Polyethylene

TABLE 1B
Relevant properties for high density polyethylene component (A)

| | | | | | | Mw(abs)/ | |
|---|---|---|---|---|---|---|---|
| | | Density | Melt index, | Mn(abs) | Mw(abs) | Mn(abs) | |
| Material | Properties | [g/cc] | I₂ [dg/min] | [g/mol] | [g/mol] | [—] | Source |
| HDPE1 | Envision | 0.958-0.965 | 0.55-0.85 | 18,211 | 132,308 | 7.27 | Envision |
| | Ecoprime (PCR) | | | | | | Plastics |
| HDPE2 | High density | 0.958 | 1.3 | 34,452 | 116,554 | 3.38 | Dow, Inc. |
| | polyethylene | | | | | | |
| HDPE3 | High density | 0.965 | 1.2 | 8,624 | 102,934 | 11.94 | Dow, Inc. |
| | polyethylene | | | | | | |
| HDPE4 | DMDD 6620 | 0.958 | 0.3 | 9,839 | 215,492 | 21.9 | Dow, Inc. |

### B. Polyethylene Enhancer and Polymerization

All raw materials (ethylene and 1-octene) and the process solvent (a narrow boiling range high-purity isoparaffinic solvent, Isopar-E) are purified with molecular sieves before introduction into the reaction environment. Hydrogen is supplied pressurized as a high purity grade and is not further purified. The reactor monomer feed stream is pressurized via a mechanical compressor to above reaction pressure. The solvent and comonomer feed are pressurized via a pump to above reaction pressure. The individual catalyst components are manually batch diluted with purified solvent and pressured to above reaction pressure. All reaction feed flows are measured with mass flow meters and independently controlled with computer automated valve control systems.

A single reactor system is used. The continuous solution polymerization reactor consists of a liquid full, non-adiabatic, isothermal, circulating, loop reactor which mimics a continuously stirred tank reactor (CSTR) with heat removal. Independent control of all fresh solvent, monomer, comonomer, hydrogen, and catalyst component feeds is possible. The total fresh feed stream to the reactor (solvent, monomer, comonomer, and hydrogen) is temperature controlled to maintain a single solution phase by passing the feed stream through a heat exchanger. The total fresh feed to the polymerization reactor is injected into the reactor at two locations with approximately equal reactor volumes between each injection location. The fresh feed is controlled with each injector receiving half of the total fresh feed mass flow. The catalyst components and co-catalysts are provided in Table 2 below.

TABLE 2

| | |
|---|---|
| Catalyst component 1 | 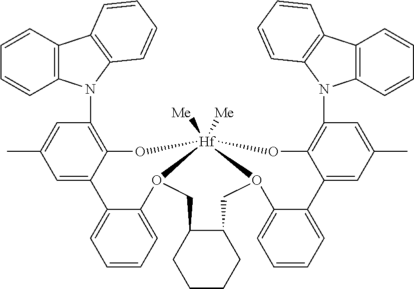 |
| Catalyst component 2 | 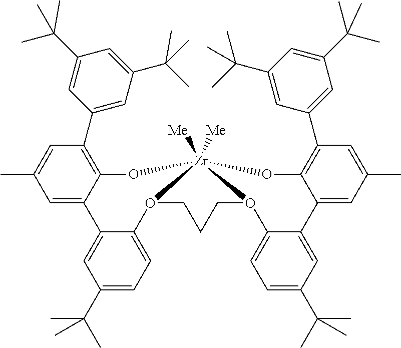 |
| Co-catalyst 1 | bis(hydrogenated tallow alkyl)methylammonium tetrakis(pentafluorophenyl) |
| | borate(1-) |
| Co-catalyst 2 | Modified methyl aluminoxane (MMOA) |

The catalyst components are injected into the polymerization reactor through injection stingers. The primary catalyst component feed is computer controlled to maintain the reactor monomer conversion at the specified target. The cocatalyst components are fed based on calculated specified molar ratios to the primary catalyst component. Immediately following the reactor feed injection location, the feed streams are mixed with the circulating polymerization reactor contents with static mixing elements. The contents of the reactor are continuously circulated through heat exchangers responsible for removing much of the heat of reaction and with the temperature of the coolant side responsible for maintaining an isothermal reaction environment at the specified temperature. Circulation around the reactor loop is provided by a pump.

The reactor effluent enters a zone where it is deactivated with the addition of and reaction with a suitable reagent (water). At this same reactor exit location other additives are added for polymer stabilization. The additives are Octadecyl 3,5-Di-Tert-Butyl-4-Hydroxyhydrocinnamate, Tetrakis(Methylene(3,5-Di-Tert-Butyl-4 Hydroxyhydrocinnamate))Methane, and Tris(2,4-Di-Tert-Butyl-Phenyl) Phosphite.

Following catalyst deactivation and additive addition, the reactor effluent enters a devolatization system where the ethylene/octene copolymer is removed from the non-polymer stream. The isolated ethylene/octene copolymer melt is pelletized and collected. The non-polymer stream passes through various pieces of equipment which separate most of the ethylene which is removed from the system. Most of the solvent and unreacted comonomer is recycled back to the reactor after passing through a purification system. A small amount of solvent and comonomer is purged from the process. The polymerization conditions for polyethylene enhancer are provided in Table 3 below.

TABLE 3

| | Enhancer 1 | Enhancer 2 |
|---|---|---|
| | (Ethylene/ | (Ethylene/ |
| | Octene | Octene |
| | Copolymer 1) | Copolymer 2) |
| Reactor Configuration (type) | Single | Single |
| Comonomer type (type) | 1-octene | 1-octene |
| Reactor Feed Solvent/Ethylene Mass | 4.27 | 3.60 |
| Flow Ratio (g/g) | | |
| Reactor Feed Comonomer/Ethylene | 0.420 | 0.627 |
| Mass Flow Ratio (g/g) | | |
| Reactor Feed Hydrogen/Ethylene Mass | 5.42E−04 | 1.48E−04 |
| Flow Ratio (g/g) | | |
| Reactor Temperature (° C.) | 145 | 160 |
| Reactor Pressure (barg) | 50 | 50 |
| Reactor Ethylene Conversion (%) | 85.5 | 90.4 |
| Reactor Primary Catalyst Type (type) | Catalyst | Catalyst |
| | component 1 | component 2 |
| Reactor Co-Catalyst 1 Type (type) | Co-catalyst 1 | Co-catalyst 1 |
| Reactor Co-Catalyst 2 Type (type) | Co-catalyst 2 | Co-catalyst 2 |
| Reactor Co-Catalyst 1 to Catalyst Molar | 2.0 | 1.4 |
| Ratio (B to Catalyst Metal ratio) | | |
| (mol/mol) | | |
| First Reactor Co-Catalyst 2 to Catalyst | 29.9 | 9.9 |
| Molar Ratio (Al to Catalyst Metal ratio) | | |
| (mol/mol) | | |
| Reactor Residence Time (min) | 7.1 | 6.9 |

The properties for polyethylene enhancer (“enhancer”) are provided in Table 4 below.

TABLE 4
Properties for polyethylene enhancer component (B)

| | | Melt | Melt | MI | | | | | |
|---|---|---|---|---|---|---|---|---|---|
| | Density | index, I₂ | index, I₁₀ | ratio, | Mn(abs) | Mw(abs) | Mw(abs)/ | LCBf/ | |
| Material | [g/cc] | [dg/min] | [dg/min] | I₁₀/I₂ | [g/mol] | [g/mol] | Mn(abs) | 1000 C. | Source |
| Enhancer 1 | 0.898 | 0.55 | 3.4 | 6.18 | 60,189 | 136,162 | 2.26 | 0.001 | Table 3 |
| (ethylene/octene | | | | | | | | | |
| copolymer 1) | | | | | | | | | |
| Enhancer 2 | 0.899 | 0.57 | 4.5 | 7.89 | 54,856 | 122,088 | 2.23 | 0.026 | Table 3 |
| (ethylene/octene | | | | | | | | | |
| copolymer 2) | | | | | | | | | |
| Enhancer 3 | 0.868 | 0.55 | 4.2 | 7.64 | 71,745 | 164,274 | 2.29 | 0.027 | Dow, Inc. |
| (ethylene/octene | | | | | | | | | |
| copolymer 3) | | | | | | | | | |
| (Engage 8150) | | | | | | | | | |

### C. Polyethylene Composition

Individual pellet components were fed into the hopper with gravimetric feeders. Gravimetric feeders dosed resin formulations into a Labtech LTE20-32 twin screw extruder at rate of 15 lbs/hr. From the extruder the resin formulation is conveyed into the blown film die. The LTE feed throat was set to 193° C. and the remaining barrel, conveying portion, and die temperature were set and maintained to 215° C. Monolayer blown films were produced from the 2 in. die diameter blown film line with a 1.0 mm die gap. To produce films an output rate of 2.4 lb/hr/in. of die circumference was targeted with pressurized ambient air inflating the film bubble to a 2.5 blow-up ratio. A dual lip air ring driven by a variable speed blower is used for all experiments. The frost line height (FLH) was maintained between 9.3 and 10.3 inches. Film thickness was targeted at 2 mils and was controlled within ±10% by adjusting the nip roller speed. The films are wound up into a roll.

TABLE 5
Parameters describing molecular distributions of each polyethylene composition

| | | GPC | GPC | | iCCD1: Mw for | iCCD2: Mw for | | | |
|---|---|---|---|---|---|---|---|---|---|
| | | (abs.) | (abs.) | GPC (abs.) | fraction eluding | fraction eluding | Ratio | MI, I₂ | |
| | Composition | Mn | Mw | Mw/Mn | between | between | iCCD1 to | [g/10 | Density |
| | (enhancer wt %/HDPE wt %) | [g/mol] | [g/mol] | [—] | 40-79° C. | 80-120° C. | iCCD2 | min] | [g/cc] |
| CS1 | 100 LLDPE Ref 1 | 22,515 | 128,007 | 5.69 | 88,494 | 173,793 | 0.51 | 1.0 | 0.918 |
| CS2 | 100 LLDPE Ref 2 | 28,056 | 118,216 | 4.21 | 69,449 | 136,938 | 0.51 | 1.0 | 0.920 |
| CS3 | 100 LLDPE Ref 3 | 23,384 | 114,642 | 4.90 | 134,376 | 89,159 | 1.51 | 0.85 | 0.918 |
| CS4 | 41/59 Enhancer 3/HDPE 2 | 18,393 | 127,368 | 6.92 | 102,233 | 110,665 | 0.92 | — | — |
| CS5 | 43/57 Enhancer 3/HDPE 1 | 15,645 | 127,409 | 8.14 | 132,210 | 103,512 | 1.28 | — | — |
| CS6 | 47/53 Enhancer 3/HDPE 3 | 13,328 | 128,100 | 9.61 | 114,949 | 92,603 | 1.24 | — | — |
| CS7 | 41/59 Enhancer 3/HDPE 4 | 16,773 | 166,291 | 9.91 | 107,924 | 146,927 | 0.73 | — | — |
| CS8 | 64/36 Enhancer 2/HDPE 2 | 22,564 | 115,460 | 5.12 | 109,806 | 119,896 | 0.92 | — | — |
| CS9 | 65/35 Enhancer 2/HDPE 1 | 23,529 | 118,205 | 5.02 | 114,203 | 112,716 | 1.01 | — | — |
| CS10 | 69/31 Enhancer 2/HDPE 3 | 13,198 | 110,728 | 8.39 | 109,624 | 111,362 | 0.98 | — | — |
| CS11 | 64/36 Enhancer 2/HDPE 4 | 12,599 | 127,384 | 10.11 | 106,374 | 148,706 | 0.72 | — | — |
| CS12 | 64/36 Enhancer 1/HDPE 2 | 19,883 | 121,384 | 6.10 | 121,229 | 121,091 | 1.00 | — | — |
| IE1 | 65/35 Enhancer 1/HDPE 1 | 23,199 | 125,927 | 5.43 | 123,001 | 116,102 | 1.06 | 0.49 | 0.920 |
| IE2 | 69/31 Enhancer 1/HDPE 3 | 16,050 | 121,442 | 7.57 | 119,957 | 109,532 | 1.10 | — | — |
| IE3 | 64/36 Enhancer 1/HDPE 4 | 12,403 | 130,022 | 10.48 | 126,154 | 155,375 | 0.81 | — | — |

wt % based on total weight composition

TABLE 6
Parameters for calculation of Low/High M-SCBDI for each polyethylene composition

| | Composition | | | SCB/ | | | | | | | | Min | |
|---|---|---|---|---|---|---|---|---|---|---|---|---|---|
| | (enhancer wt %/ | Log | dWf | 1000° C. | | Low | dWf | Low M- | High | dWf | High M- | dWf | LS |
| | HDPE wt %) | Mₚ | LogMₚ | Peak | Log(M_{SCB Peak}) | LogM_{range} | Low | SCBDI | LogM_{range} | High | SCBDI | ratio | S/N |
| CS1 | 100 LLDPE Ref 1 | 4.84 | 0.79 | 18.36 | 3.89 | (3.39)^{a} | 0.044 | CNC^{c, d} | 3.99-4.49 | 0.610 | −1.3 | 5.5 | 435.3 |
| | | | | | | 3.29-3.79 | | | | | | | |
| CS2 | 100 LLDPE Ref 2 | 4.88 | 0.81 | 11.96 | 3.87 | (3.43)^{a} | 0.019 | CNC^{c, d} | 3.97-4.77 | 0.595 | −1.9 | 2.3 | 477.6 |
| | | | | | | 3.27-3.77 | | | | | | | |
| CS3 | 100 LLDPE Ref 3 | 4.94 | 0.82 | 16.00 | 5.36 | 4.76-5.26 | 0.763 | 8.0 | 5.46-5.96 | 0.028 | CNC^{c, d} | 3.4 | 540.9 |
| | | | | | | | | | (5.88)^{b} | | | | |
| CS4 | 41/59 Enhancer 3/ | 5.00 | 0.93 | 22.5 | 5.27 | 4.67-5.17 | 0.672 | 12.5 | 5.37-5.87 | 0.055 | CNC^{d} | 5.9 | 400.4 |
| | HDPE 2 | | | | | | | | | | | | |
| CS5 | 43/57 Enhancer 3/ | 5.03 | 0.73 | 28.8 | 5.24 | 4.64-5.14 | 0.580 | 19.0 | 5.34-5.84 | 0.089 | −33.5 | 12.2 | 481.0 |
| | HDPE 1 | | | | | | | | | | | | |
| CS6 | 47/53 Enhancer 3/ | 5.19 | 0.69 | 35.5 | 4.88 | 4.28-4.78 | 0.396 | 58.4 | 4.98-5.48 | 0.495 | −28.7 | 57.4 | 611.3 |
| | HDPE 3 | | | | | | | | | | | | |
| CS7 | 41/59 Enhancer 3/ | 5.07 | 0.71 | 28.1 | 5.00 | 4.40-4.90 | 0.382 | 29.5 | 5.10-5.60 | 0.314 | −28.3 | 44.2 | 643.9 |
| | HDPE 4 | | | | | | | | | | | | |
| CS8 | 64/36 Enhancer 2/ | 4.98 | 1.02 | 14.4 | 4.99 | 4.39-4.89 | 0.356 | 3.3 | 5.09-5.59 | 0.208 | −6.9 | 20.4 | 301.7 |
| | HDPE 2 | | | | | | | | | | | | |
| CS9 | 65/35 Enhancer 2/ | 4.96 | 0.88 | 17.6 | 5.01 | 4.41-4.91 | 0.453 | 9.8 | 5.11-5.61 | 0.192 | −11.0 | 21.8 | 340.2 |
| | HDPE 1 | | | | | | | | | | | | |
| CS10 | 69/31 Enhancer 2/ | 5.04 | 0.79 | 19.9 | 4.78 | 4.18-4.68 | 0.321 | 23.8 | 4.88-5.38 | 0.513 | −11.5 | 40.6 | 312.7 |
| | HDPE 3 | | | | | | | | | | | | |
| CS11 | 64/36 Enhancer 2/ | 4.98 | 0.76 | 17.2 | 4.90 | 4.30-4.80 | 0.343 | 11.2 | 5.00-5.50 | 0.310 | −12.0 | 40.8 | 316.9 |
| | HDPE 4 | | | | | | | | | | | | |
| CS12 | 64/36 Enhancer 1/ | 4.98 | 0.96 | 14.6 | 5.09 | 4.49-4.99 | 0.463 | 3.5 | 5.19-5.69 | 0.143 | −6.0 | 14.9 | 460.4 |
| | HDPE 2 | | | | | | | | | | | | |
| IE1 | 65/35 Enhancer 1/ | 5.00 | 0.85 | 17.6 | 5.05 | 4.45-4.95 | 0.464 | 9.7 | 5.15-5.65 | 0.198 | −8.5 | 23.3 | 403.7 |
| | HDPE 1 | | | | | | | | | | | | |
| IE2 | 69/31 Enhancer 1/ | 5.12 | 0.83 | 20.0 | 4.83 | 4.23-4.73 | 0.315 | 24.8 | 4.93-5.43 | 0.551 | −11.6 | 38.0 | 644.4 |
| | HDPE 3 | | | | | | | | | | | | |
| IE3 | 64/36 Enhancer 1/ | 4.99 | 0.78 | 17.3 | 4.95 | 4.35-4.85 | 0.358 | 10.5 | 5.05-5.55 | 0.293 | −11.5 | 37.6 | 304.3 |
| | HDPE 4 | | | | | | | | | | | | |

^{a}Value in parenthesis corresponds to lowest measured LogM value in the sample.
^{b}Value in parenthesis corresponds to highest measured LogM value in the sample.
^{c}CNC = cannot calculate; not enough data in the LogM_{range} to calculate either Low M-SCBDI or High M-SCBDI values. Refer to method description for details (section TDGPC and Absolute Molecular Weighted Short Chain Branching Distribution Index).
^{d}CNC = cannot calculate; minimum signal intensity requirement over calculation range not satisfied (i.e., Min dWf ratio <10%). Refer to method description for details (section TDGPC and Absolute Molecular Weighted Short Chain Branching Distribution Index).
wt % based on total weight composition

The present polyethylene composition has a unique shape of the SCBD curve across the polymer molecular weight. This unique SCBD shape is defined by a peak value and two slope calculations on each side of the peak, referred to as “low M-SCBDI” and “high M-SCBDI”.

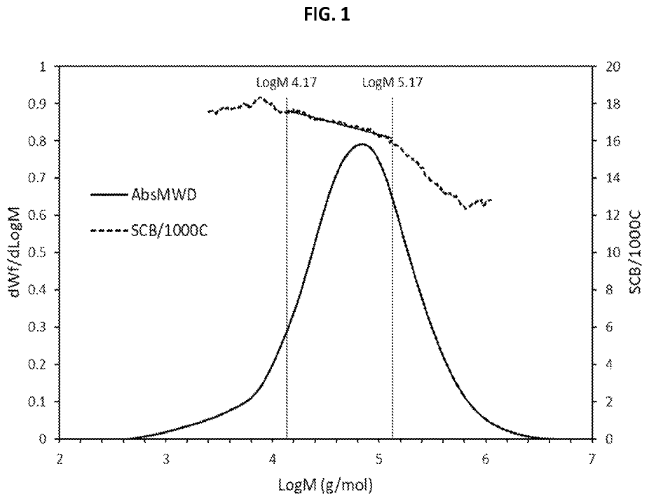

FIG. 1 is a graph showing SCBD across molecular weight (Log M) for comparative sample 1 (CS1). A linear regression using excel LINEST function or similar is applied to x-coordinate absolute Log M values within the molecular weight range of Log M=4.17-5.17 (15,000-150,000 g/mol) and their corresponding y-coordinate SCB/1000C values. The resulting fit slope value, termed the molecular weight short chain branching distribution index (M-SCBDI), describes the magnitude of the change in comonomer as a function of molecular weight and whether that incorporation is forward, reverse or uniform. CS1 lacks key features in the SCBD vs log M plot that characterize the inventive compositions. In this case the comonomer incorporation across log M is fully described by a single slope value of −1.3.

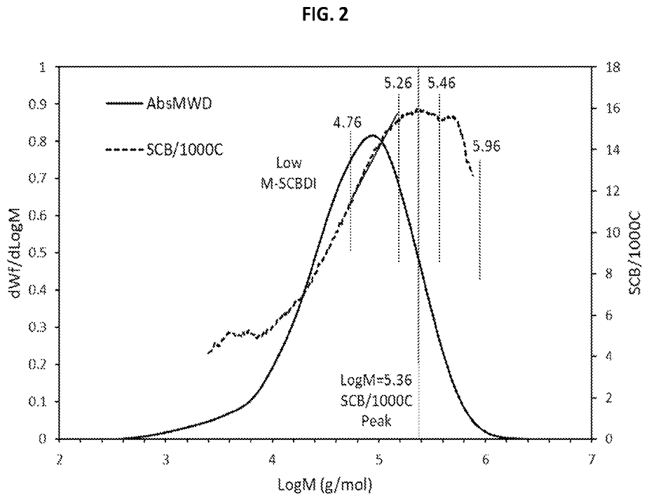

FIG. 2 is a graph showing SCBD across molecular weight (Log M) for is CS3. CS3 shows that the requisite calculation conditions are not met to produce both a low M-SCBDI and a high M-SCBDI values (i.e., only low M-SCBDI calculation is possible). The molecular weight at the SCB/1000C Peak (Log(M_{SCB Peak})) is 5.36. The low M-SCBDI is calculated in the region bounded by [Log(M_{SCB Peak})−0.6] to [Log(M_{SCB Peak})−0.1]. In this case, the calculation range for low M-SCBDI spans from Log M=4.76 to Log M=5.26. CS3 satisfies the calculation criterion requiring 51 consecutive equally spaced data points within the defined 0.5 Log M calculation range for low M-SCBDI. The high M-SCBDI is calculated in the region bounded by [Log(M_{SCB Peak})+0.1] to [Log(M_{SCB Peak})+0.6]. In this case, the calculation range for high M-SCBDI spans from Log M=5.46 to Log M=5.96. CS3 does not satisfy the calculation criterion requiring 51 consecutive equally spaced data points within the defined 0.5 Log M calculation range for high M-SCBDI. Therefore, a high M-SCBDI cannot be calculated, and CS3 does not meet the requirements for the inventive composition.

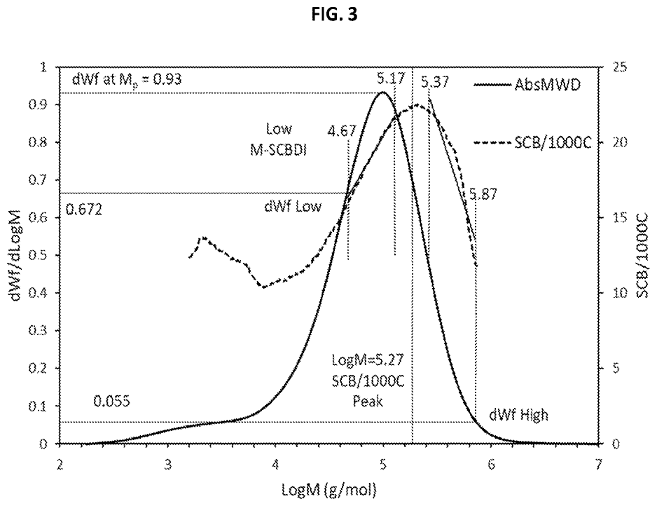

FIG. 3 is a graph showing SCBD across molecular weight (Log M) for CS4. CS4 shows that the requisite data quality parameters for the calculation conditions of a low M-SCBDI and a high M-SCBDI are not met. In this instance there are sufficient number of data points on either side of the SCB/1000C Peak to calculate both a low M-SCBDI and a high M-SCBDI. However, the requirement of a “minimum dWf ratio”, determined from the ratio of the lowest value of either “dWf Low” or “dWf high” to the value of “dWf at Mₚ”, where dWf Low is the lowest dWf/d Log M value in the calculation region for the low M-SCBDI, dWf High is the lowest dWf/d Log M value in the calculation region for the high M-SCBDI, and dWf at Mₚ is the dWf/d Log M at the peak of the molecular weight (Log M) distribution, of 10.0% or greater is not satisfied. In the case of CS4, dWf Low=0.672, dWf high=0.055, and dWf at Mₚ=0.93. Accordingly, the minimum dWf ratio=0.055/0.93*100=5.9%, which is below the 10% minimum requirement for data quality. The implication is that the data used in the high M-SCBDI calculation comes from the tail of the MWD distribution where the signal-to-noise ratio (S/N) is low.

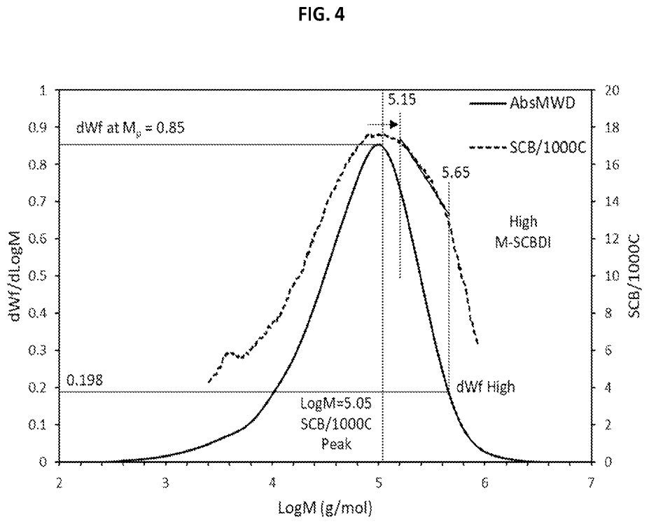

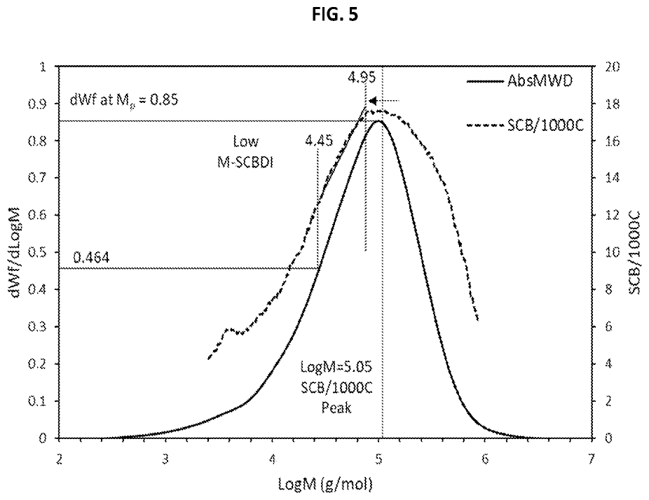

FIGS. 4-5 are graphs showing SCBD across molecular weight (Log M) for IE1. In FIG. 4, relevant details for the high M-SCBDI calculation are shown for IE1. The calculation of the high M-SCBDI first requires the SCB/1000C Peak to be identified and its corresponding Log(M_{SCB Peak}) value. For IE1, Log(M_{SCB Peak})=5.05. The calculation range for the high M-SCBDI value is defined from [Log(M_{SCB Peak})+0.1] to [Log(M_{SCB Peak})+0.6]. For IE1, the upper and lower bounds for the high M-SCBDI calculation range are Log M=5.65 and Log M=5.15, respectively. A linear regression using a LINEST function in Excel or similar is applied to the x-coordinate Log M values within this bound and the corresponding y-coordinate SCB/1000C values to generate a slope value, which is equal to the high M-SCBDI. IE1 has the required 51 non-zero data points spaced 0.01 apart on the Log M scale in order to perform the calculation. The “dWf high ratio” is calculated using dWf Log Mₚ=0.85 (i.e., dWf/d Log M value at the molecular weight peak of the Abs MWD curve) and dWf high=0.198 (corresponding to the lowest dWf/d Log M value in the high M-SCBDI calculation range). In this instance, dWf high ratio=0.198/0.85*100=23.3%. Since the dWf high ratio exceeds 10.0%, the high M-SCBDI calculation is performed without using lower S/N data at the higher molecular weight tail of the MWD.

In FIG. 5, the relevant details for the low M-SCBDI calculation are shown for IE1. The calculation of the low M-SCBDI first requires the SCB/1000C Peak to be identified and its corresponding Log(M_{SCB Peak}) value. For IE1, Log(M_{SCB Peak})=5.05. The calculation range for the low M-SCBDI value is defined from [Log(M_{SCB Peak})−0.6] to [Log(M_{SCB Peak})−0.1]. For IE1, the upper and lower bounds for the low M-SCBDI calculation range are Log M=4.95 and Log M=4.45, respectively. A linear regression using a LINEST function in Excel or similar is applied to the x-coordinate Log M values within this bound and the corresponding y-coordinate SCB/1000C values to generate a slope value, which is equal to the low M-SCBDI. IE1 has the required 51 non-zero data points spaced 0.01 apart on the Log M scale in order to perform the calculation. The “dWf low ratio” is calculated using dWf Log Mₚ=0.85 (i.e., dWf/d Log M value at the molecular weight peak of the Abs MWD curve) and dWf low=0.464 (corresponding lowest dWf/d Log M value in the low M-SCBDI calculation range). For IE1, dWf low ratio=0.464/0.85*100=54.6%. Since the dWf low ratio exceeds 10.0%, the low M-SCBDI calculation is performed without using lower S/N data at the lower molecular weight tail of the MWD.

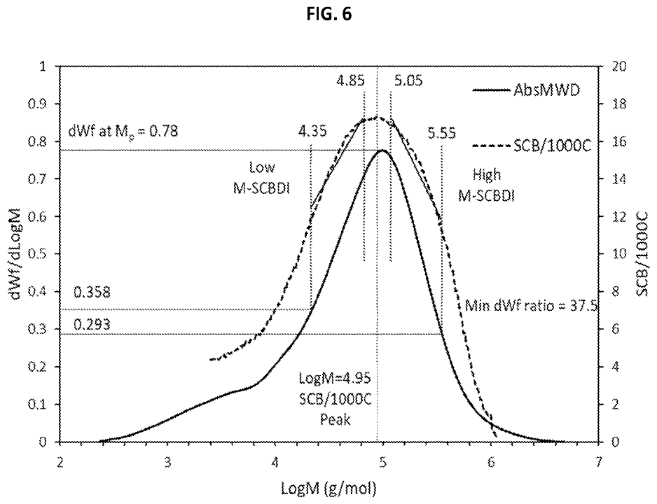

FIG. 6 shows a graph showing SCBD across molecular weight (Log M) for IE3. IE3 meets all the requirements to perform the low and high M-SCBDI calculations. It contains enough SCB/1000C data points on either side of Log(M_{SCB Peak})=4.95 and also satisfies the minimum dWf ratio requirement.

TABLE 7
Mechanical properties

| | | High | | | | | | | | | MD | CD | |
|---|---|---|---|---|---|---|---|---|---|---|---|---|---|
| | | density | Low | Low | | Overall | | | | | 2% | 2% | |
| | | comp. | density | density | | composi- | | | | Punc- | Secant | Secant | Ki- |
| | Composition | Mw(abs)/ | comp. | comp. | Overall | tion | IDI | MD | CD | ture | Modu- | Modu- | net- |
| | (enhancer wt %/ | Mn(abs) | Density | LCBf/1000 | composition | GPC(abs.) | energy | Tear | Tear | [ft-lbf/ | lus | lus | ic |
| | HDPE wt %) | [—] | [g/cc] | C.^{a} | iCCD1:iCCD2 | Mw/Mn | [J] | [gf] | [gf] | in³] | [ksi] | [ksi] | COF |
| CS1 | 100 | N/A | N/A | N/A | 0.51 | 5.69 | 0.19 | 272 | 574 | 99 | 37.0 | 39.1 | 0.33 |
| | LLDPE Ref 1 | | | | | | | | | | | | |
| CS2 | 100 | N/A | N/A | N/A | 0.51 | 4.21 | 0.32 | 808 | 1166 | 73 | 38.8 | 44.7 | 0.49 |
| | LLDPE Ref 2 | | | | | | | | | | | | |
| CS3 | 100 | N/A | N/A | N/A | 1.51 | 4.90 | 1.68 | 660 | 961 | 202 | 31.7 | 35.8 | 0.62 |
| | LLDPE Ref 3 | | | | | | | | | | | | |
| CS4 | 41/59 Enhancer | 3.38 | 0.868 | 0.027 | 0.92 | 6.92 | blk | blk | blk | blk^{b} | blk^{b} | blk^{b} | blk^{b} |
| | 3/HDPE 2 | | | | | | | | | | | | |
| CS5 | 43/57 Enhancer | 7.27 | 0.868 | 0.027 | 1.28 | 8.14 | 0.56 | 227 | 992 | 64 | 39.9 | 48.3 | 0.59 |
| | 3/HDPE 1 | | | | | | | | | | | | |
| CS6 | 47/53 Enhancer | 11.94 | 0.868 | 0.027 | 1.24 | 9.61 | 1.38 | 787 | 1331 | 143 | 39.4 | 44.7 | 0.63 |
| | 3/HDPE 3 | | | | | | | | | | | | |
| CS7 | 41/59 Enhancer | 21.9 | 0.868 | 0.027 | 0.73 | 9.91 | 1.06 | 642 | 1425 | 134 | 45.7 | 55.5 | 0.41 |
| | 3/HDPE 4 | | | | | | | | | | | | |
| CS8 | 64/36 Enhancer | 3.38 | 0.898 | 0.026 | 0.92 | 5.12 | 1.23 | 704 | 1287 | 146 | 42.9 | 42.1 | 0.74 |
| | 2/HDPE 2 | | | | | | | | | | | | |
| CS9 | 65/35 Enhancer | 7.27 | 0.898 | 0.026 | 1.01 | 5.02 | 1.20 | 538 | 1133 | 100 | 34.5 | 37.0 | 0.48 |
| | 2/HDPE 1 | | | | | | | | | | | | |
| CS10 | 69/31 Enhancer | 11.94 | 0.898 | 0.026 | 0.98 | 8.39 | 1.79 | 750 | 1248 | 159 | 43.2 | 44.6 | 0.61 |
| | 2/HDPE 3 | | | | | | | | | | | | |
| CS11 | 64/36 Enhancer | 21.9 | 0.898 | 0.026 | 0.72 | 10.11 | 1.59 | 783 | 1136 | 163 | 39.1 | 42.7 | 0.47 |
| | 2/HDPE 4 | | | | | | | | | | | | |
| CS12 | 64/36 Enhancer | 3.38 | 0.898 | 0.001 | 1.00 | 6.10 | 1.87 | 651 | 1035 | 151 | 38.0 | 38.3 | 0.78 |
| | 1/HDPE 2 | | | | | | | | | | | | |
| IE1 | 65/35 Enhancer | 7.27 | 0.898 | 0.001 | 1.06 | 5.43 | 2.64 | 449 | 1097 | 99 | 39.7 | 43.2 | 0.55 |
| | 1/HDPE 1 | | | | | | | | | | | | |
| IE2 | 69/31 Enhancer | 11.94 | 0.898 | 0.001 | 1.10 | 7.57 | 5.50 | 757 | 984 | 175 | 39.0 | 42.7 | 0.59 |
| | 1/HDPE 3 | | | | | | | | | | | | |
| IE3 | 64/36 Enhancer | 21.9 | 0.898 | 0.001 | 0.81 | 10.48 | 5.73 | 786 | 1231 | 155 | 37.9 | 41.9 | 0.61 |
| | 1/HDPE 4 | | | | | | | | | | | | |

^{a}LCBf/1000 C. value for enhancer only.
^{b}blk = blocked sample; unable to separate film for testing.
wt % based on total weight composition

Inventive compositions (IE1-IE3) exhibit better balance of abuse and stiffness properties (Table 7) compared to commercially available resins (CS1-CS3). These inventive compositions IE1-IE3 are enabled by specific design features of each of the components. A HDPE component with broad molecular weight distribution, Mw(abs)/Mn(abs)>4, is found to be a key feature in providing better balance of properties. However, this HDPE component with broad molecular weight distribution needs to be combined with an appropriate polyethylene enhancer resin to maximize the performance afforded by the polyethylene composition. Specifically, both density and long chain branching frequency (LCBf) are found to be critical design elements for the polyethylene enhancer component. When comparing the performance of compositions with Enhancer 1 (IE1-IE3) or Enhancer 2 (CS8-CS11), both having a density of 0.898 g/cc, with compositions with Enhancer 3 (CS4-CS7), having a density of 0.868 g/cc, in Table 7, a significant drop in IDI energy and lower MD tear and puncture for CS4-CS7 is observed. When comparing the performance of polyethylene compositions with Enhancer 1 (IE1-IE3), having a LCBf/1000C of 0.001, to compositions with Enhancer2 (CS8-CS11), having a LCBf/1000C of 0.026, in Table 7, a significant drop in IDI energy for CS8-CS11 is observed.

Further comparison of the performance of IE1-IE3 to CS12 in Table 7 reinforces the need of a HDPE component with broad molecular weight distribution in the composition, which affords materials with much better balance of IDI energy, tear, puncture and stiffness.

IE1 contains PCR. It is known that PCR has contaminants that degrade mechanical performance. In spite of this, IE1 offers a way to produce a material that provides comparable performance to that of several commercially available virgin resins (CS1-CS3).

It is specifically intended that the present disclosure not be limited to the embodiments and illustrations contained herein, but include modified forms of those embodiments including portions of the embodiments and combination of elements of different embodiments as come within the scope of the following claims.

1. A polyethylene composition comprising:
(A) at least 25 wt % of a high density polyethylene having
(i) a density from 0.950 g/cm³ to 0.970 g/cm³,
(ii) a melt index (12) from 0.2 g/10 minutes to 2 g/10 minutes,
(iii) a molecular weight distribution (M_{w(abs)}/M_{n(abs)}) from greater than 4.0 to 30.0;
(B) a polyethylene enhancer that is an ethylene/C₄-C₈ α-olefin copolymer having
(i) a density from 0.880 g/cm³ to 0.910 g/cm³,
(ii) a melt index from 0.2 to 2.0 g/10 minutes, and
(iii) LCBf/1000C value less than 0.015;
wherein the polyethylene composition has
(1) a density from 0.915 g/cm³ to 0.925 g/cm³,
(2) a melt index (12) from 0.3 g/10 minutes to 1.0 g/10 minutes,
(3) a Mw(abs)/Mn(abs) value from 5.0 to 11.0,
(4) a low M-SCBDI value from 9.0 to 25.0,
(5) a high M-SCBDI value from −8.0 to −12.0,
(6) a first polyethylene fraction having
(a) at least one peak in a temperature range from 40° C. to 79° C., and
(b) an average M_{w} from 100,000 g/mol to 200,000 g/mol on an elution profile via improved comonomer composition distribution (iCCD) analysis method,
(7) a second polyethylene fraction having
(a) at least one peak in a temperature range from 80° C. and 120° C., and
(b) an average M_{w} from 90,000 g/mol to 250,000 g/mol on the elution profile via improved iCCD analysis method, and
(8) a ratio of the average M_{w} of the first polyethylene fraction to the average M_{w} of the second polyethylene fraction is from 0.6 to 1.2.

2. The composition of claim 1, wherein the composition comprises from
(A) from 30 wt % to 60 wt % of the high density polyethylene; and
(B) from 40 wt % to 70 wt % of the polyethylene enhancer.

3. The composition of claim 1, wherein the composition has a molecular weight distribution (M_{w(abs)}/M_{n(abs)}) of greater than 5.0.

4. The composition of claim 1, wherein the high density polyethylene has a molecular weight distribution (M_{w(abs)}/M_{n(abs)}) of greater than 4.

5. The composition of claim 1, wherein the high density polyethylene is a post-consumer recycled high density polyethylene.

6. The composition of claim 1, further comprising an additive.

7. A film comprising:
(A) at least 25 wt % of a high density polyethylene having
(i) a density from 0.950 g/cm³ to 0.970 g/cm³,
(ii) a melt index (12) from 0.2 g/10 minutes to 2 g/10 minutes,
(iii) a molecular weight distribution (M_{w(abs)}/M_{n(abs)}) from greater than 4.0 to 30.0;
(B) a polyethylene enhancer that is an ethylene/C₄-C₈ α-olefin copolymer having
(i) a density from 0.880 g/cm³ to 0.910 g/cm³,
(ii) a melt index from 0.2 to 2.0 g/10 minutes, and
(iii) LCBf/1000C value less than 0.015;
wherein the polyethylene composition has
(1) a density from 0.915 g/cm³ to 0.925 g/cm³,
(2) a melt index (12) from 0.3 g/10 minutes to 1.0 g/10 minutes,
(3) a Mw(abs)/Mn(abs) value from 5.0 to 11.0,
(4) a low M-SCBDI value from 9.0 to 25.0,
(5) a high M-SCBDI value from −8.0 to −12.0,
(6) a first polyethylene fraction having
(a) at least one peak in a temperature range from 40° C. to 79° C., and
(b) an average M_{w} from 100,000 g/mol to 200,000 g/mol on an elution profile via improved comonomer composition distribution (iCCD) analysis method,
(7) a second polyethylene fraction having
(a) at least one peak in a temperature range from 80° C. and 120° C., and
(b) an average M_{w} from 90,000 g/mol to 250,000 g/mol on the elution profile via improved iCCD analysis method, and
(8) a ratio of the average M_{w} of the first polyethylene fraction to the average M_{w} of the second polyethylene fraction is from 0.6 to 1.2.

8. The film of claim 7 wherein the film has a property selected from the group consisting of
an Instrumented Dart Impact energy from 2.5 J to 6 J;
a machine direction tear strength from 400 gf to 800 gf;
a cross direction tear strength from 800 gf to 1300 gf;
a puncture resistance from 90 ft-lbf/in³ to 190 ft-lbf/in³;
a machine direction 2% modulus from 37 ksi to 41 ksi;
a cross direction 2% modulus from 41 ksi to 44 ksi;
a kinetic coefficient of friction from 0.5 to 0.65; and
combinations thereof.
